(19) United States
(12) Patent Application Publication
(10) Pub. No.: US 2011/0271590 A1
(43) Pub. Date: Nov. 10, 2011

(54) Garden System

(76) Inventor: Iaz Poolar, Toronto (CA)

(21) Appl. No.: 13/030,874

(22) Filed: Feb. 18, 2011

Related U.S. Application Data
(60) Provisional application No. 61/307,660, filed on Feb. 24, 2010.

(51) Int. Cl. A01G 9/02

(52) U.S. Cl. 47/66.6

(57) ABSTRACT

A garden system is provided comprising: a planter for containing soil for growing one or more plants, the planter comprising at least one port for permitting plant growth therethrough; a water source; a pump connected to the water source at a pump inlet; a water line connected to a pump outlet, the water line extending into the planter for delivering water to soil contained in the planter; a power source for powering the pump for delivering water from the water source to the water line; and a control module connected between the power source and the pump to provide a timing signal to the pump for delivering water according to a water cycle.

This application claims priority from U.S. Provisional Application No. 61/307,660 filed on Feb. 24, 2010, the entire contents of which are incorporated herein by reference.

### TECHNICAL FIELD

The following relates generally to gardening and more particularly to garden systems.

### BACKGROUND

Concerns over various environmental issues surrounding the food supply, concerns such as the use of pesticides and fertilizers, the cost and pollution as a result of having to ship produce, amount of water used in the process of growing the food, to name a few, have caused people to begin to look for local alternatives for food, including growing their own.

One problem faced by a consumer that wishes to grow their own food is the space required to grow it. For example, the “real estate” associated with plants and vegetables can deter apartment and condominium dwellers from growing their own food and even having flowers or other plants on their balconies. Even for detached homes having some yard space, the space associated with growing various plants such as vegetables can be prohibitive or at least undesirable.

Another problem faced by consumers that do plan to have their own gardens and grow their own food is the time and timing required to tend to a garden.

### SUMMARY

In one aspect, there is provided a garden system comprising: a planter for containing soil for growing one or more plants, the planter comprising at least one port for permitting plant growth therethrough; a water source; a pump connected to the water source at a pump inlet; a water line connected to a pump outlet, the water line extending into the planter for delivering water to soil contained in the planter; a power source for powering the pump for delivering water from the water source to the water line; and a control module connected between the power source and the pump to provide a timing signal to the pump for delivering water according to a water cycle.

### BRIEF DESCRIPTION OF THE DRAWINGS

Embodiments will now be described by way of example only with reference to the appended drawings wherein:

### DESCRIPTION OF THE DRAWINGS

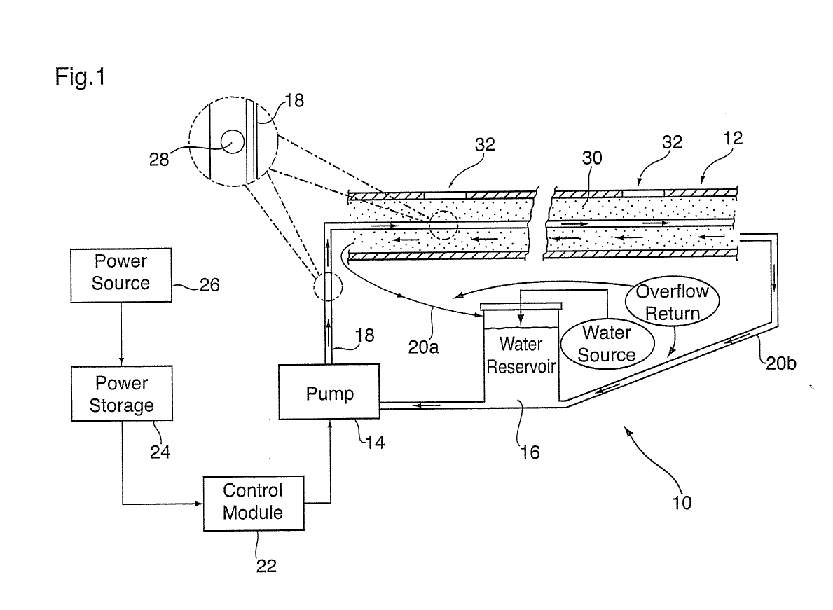

FIG. 1 is a schematic diagram of a garden system.

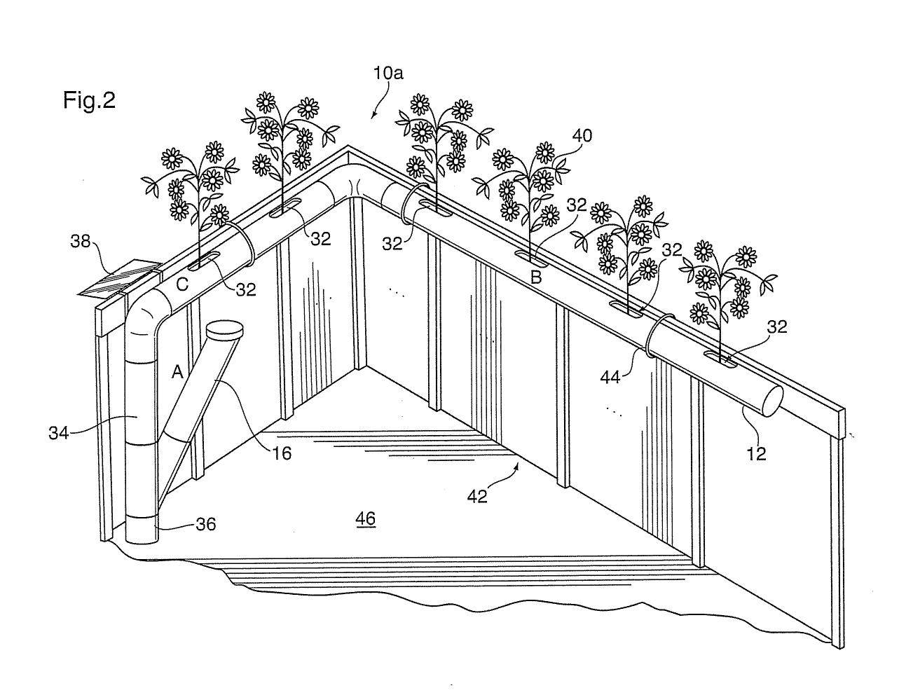

FIG. 2 is a perspective view of a garden system supported by a balcony.

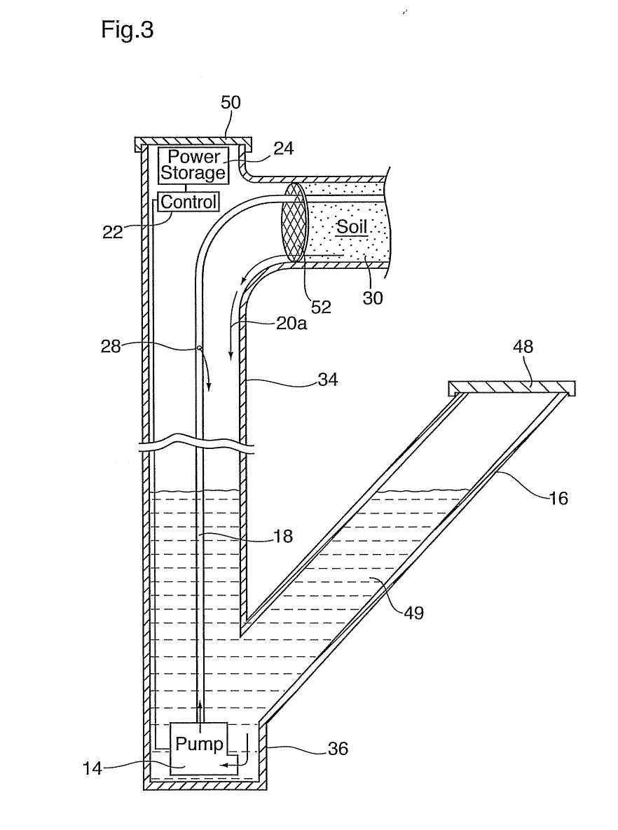

FIG. 3 is a partial cross-sectional view of portion A of the garden system of FIG. 2.

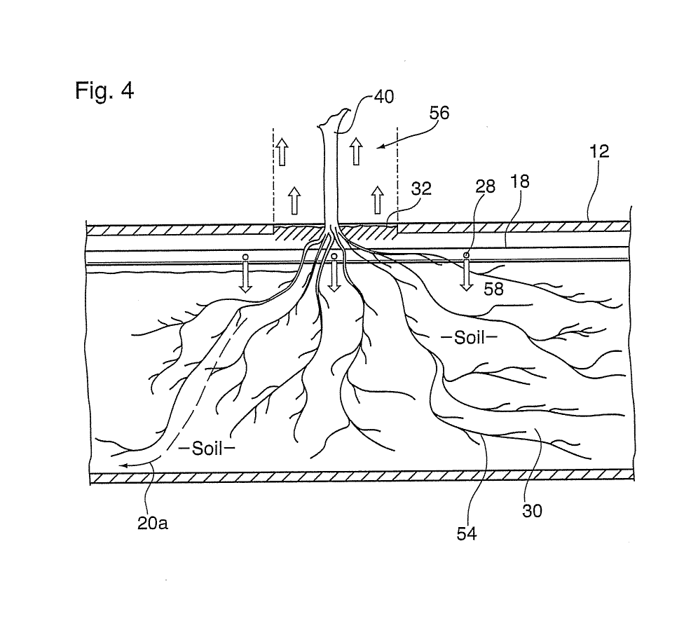

FIG. 4 is a partial cross-sectional view of portion B of the garden system of FIG. 2.

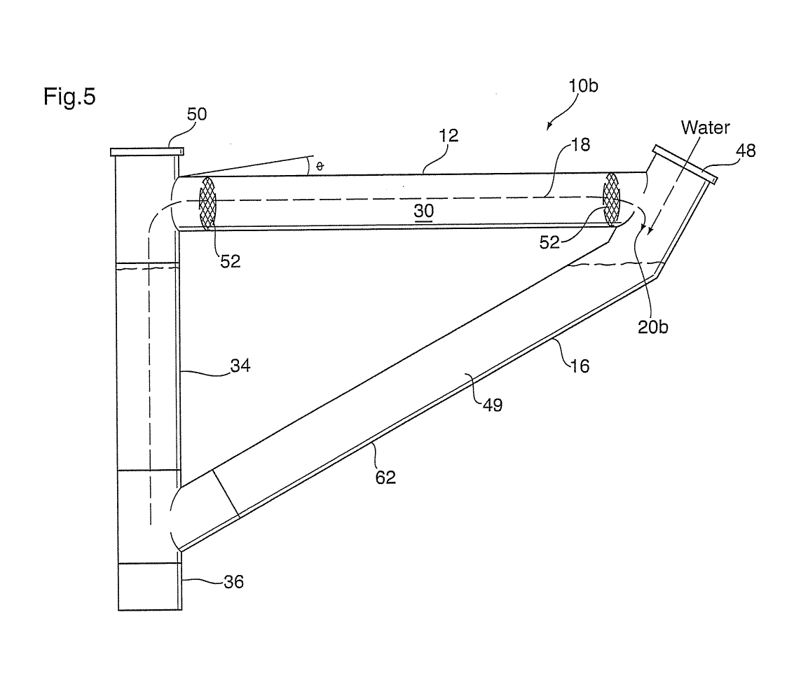

FIG. 5 is a schematic diagram showing an embodiment of a garden system comprising an integrated water reservoir and water return path.

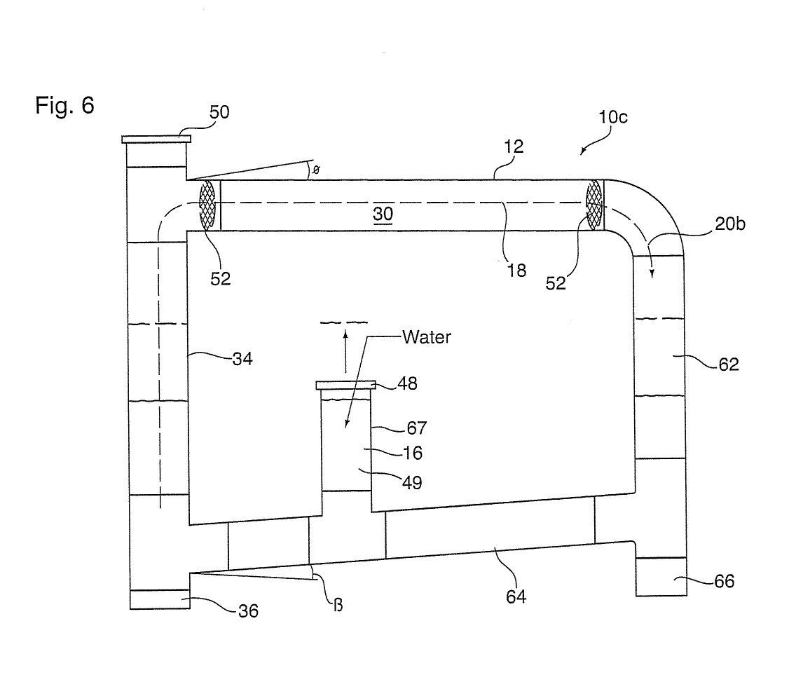

FIG. 6 is a schematic diagram showing an embodiment of a free-standing garden system.

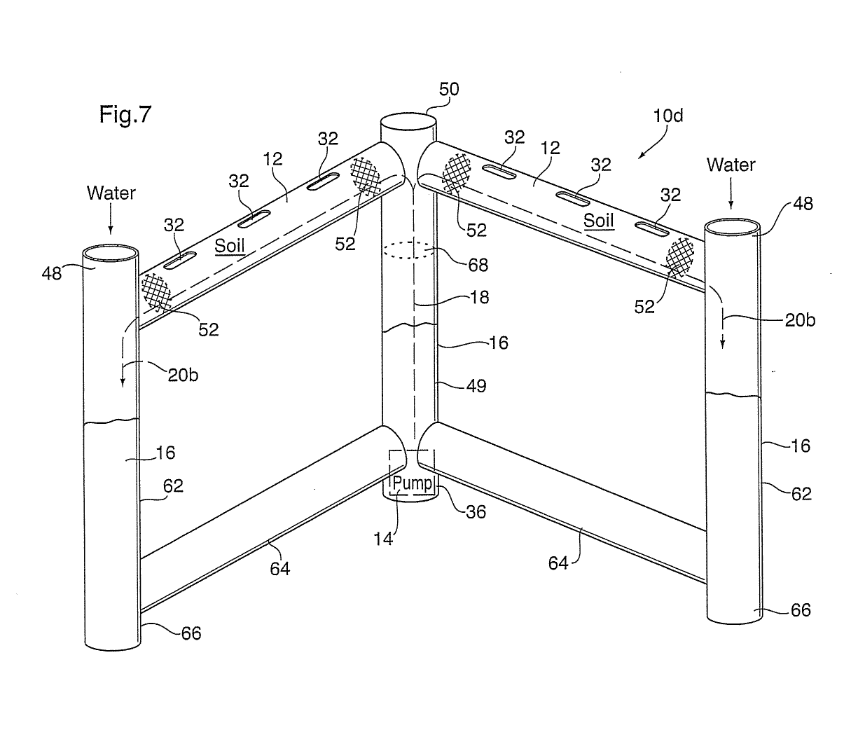

FIG. 7 is a schematic diagram showing another embodiment of a free-standing garden system.

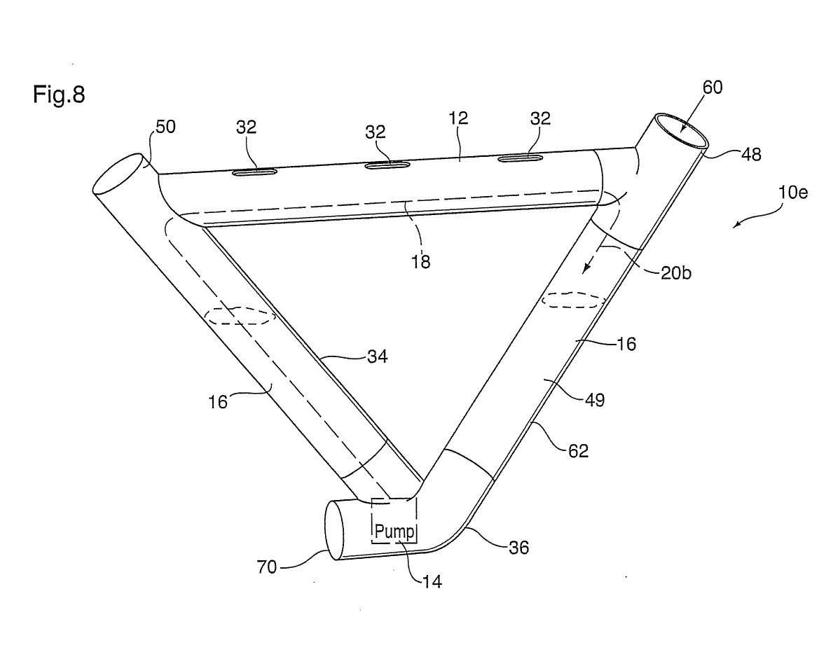

FIG. 8 is a schematic diagram showing yet another embodiment of a free-standing garden system.

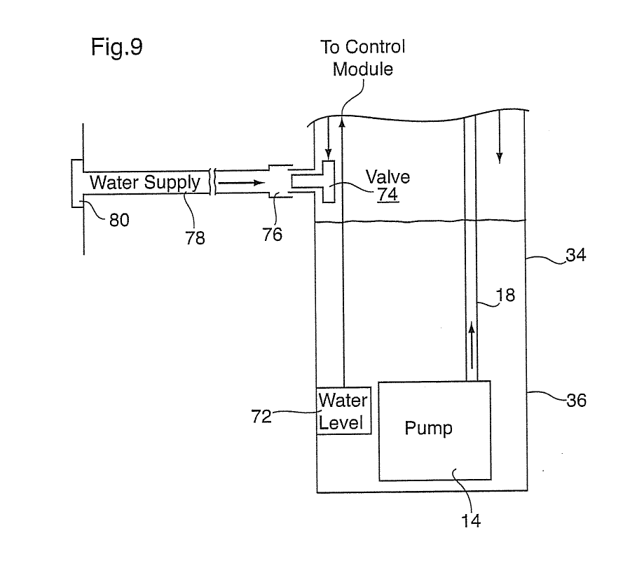

FIG. 9 is a schematic diagram showing a self filling water reservoir for a garden system.

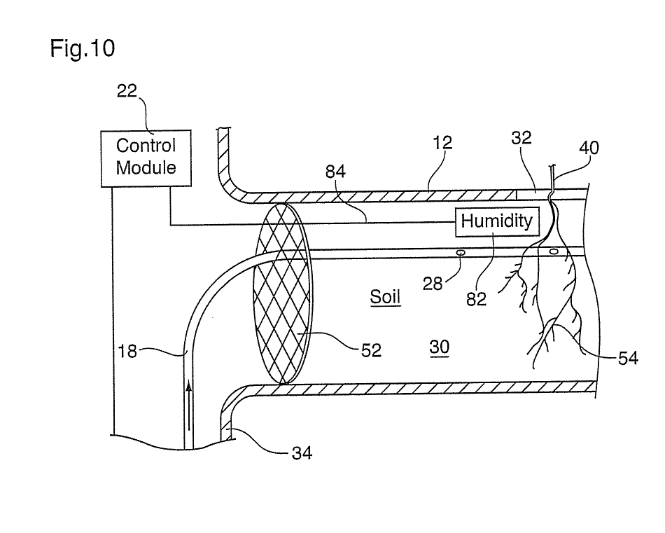

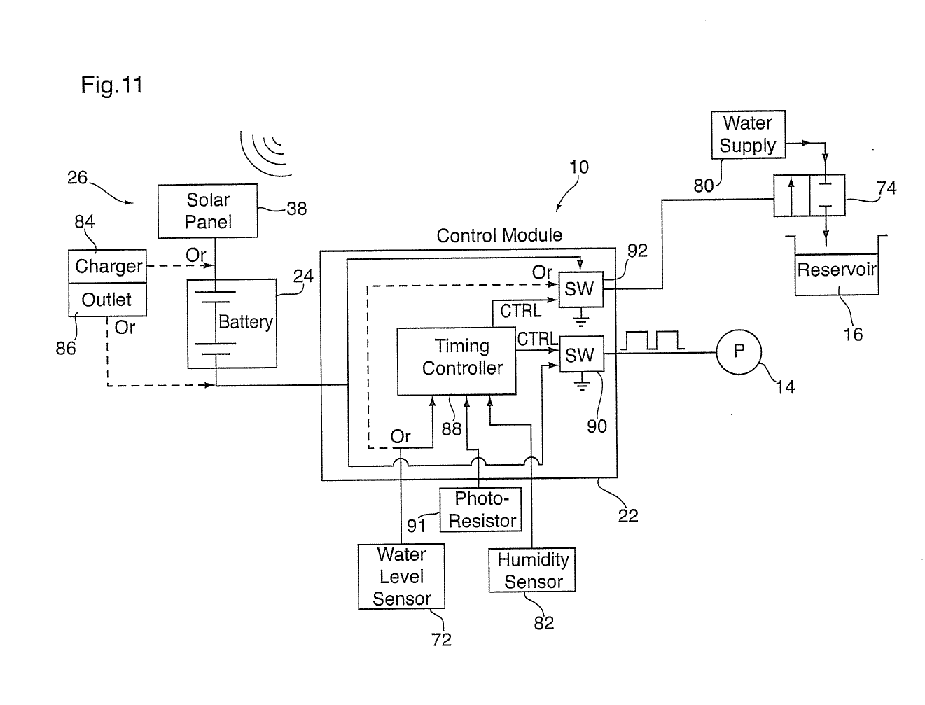

FIG. 10 is a partial cross-sectional view of portion C of the garden system of FIG. 2 comprising a humidity sensor for enabling automatic watering.

FIG. 11 is an electrical schematic diagram of one example configuration for the control module and its connections to the power sub-system, pump and watering sub-system of a garden system.

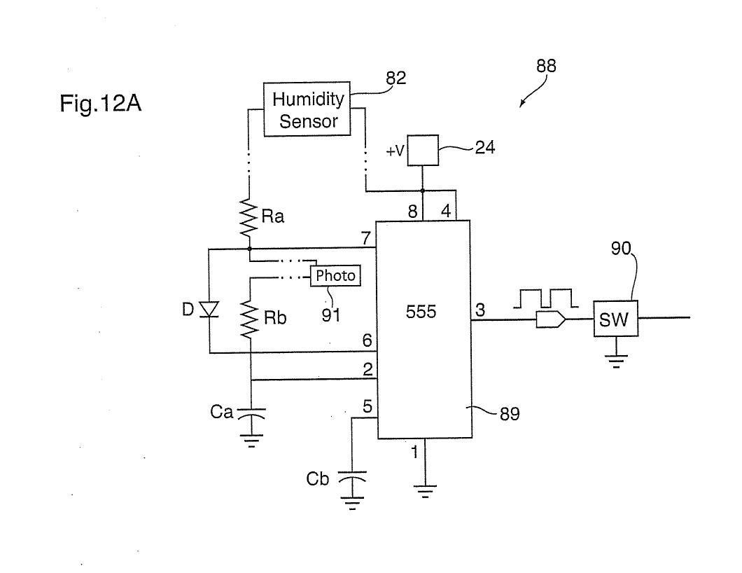

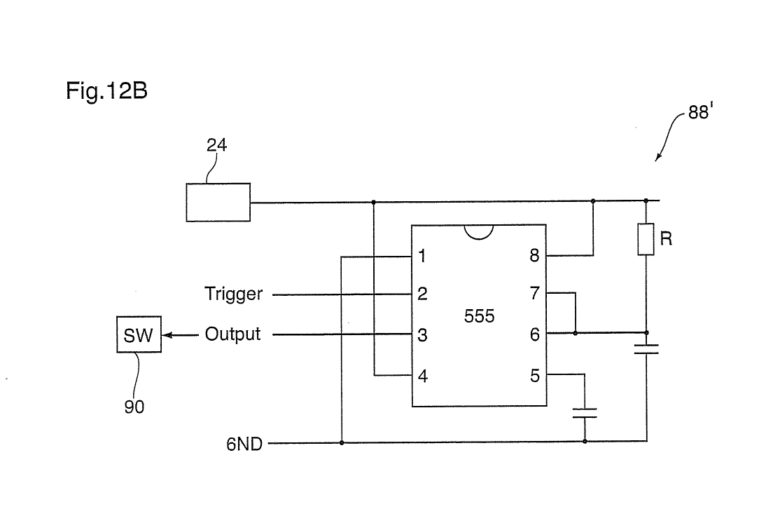

FIGS. 12A and 12B are electrical schematic diagrams of example configurations for the timing controller of FIG. 11.

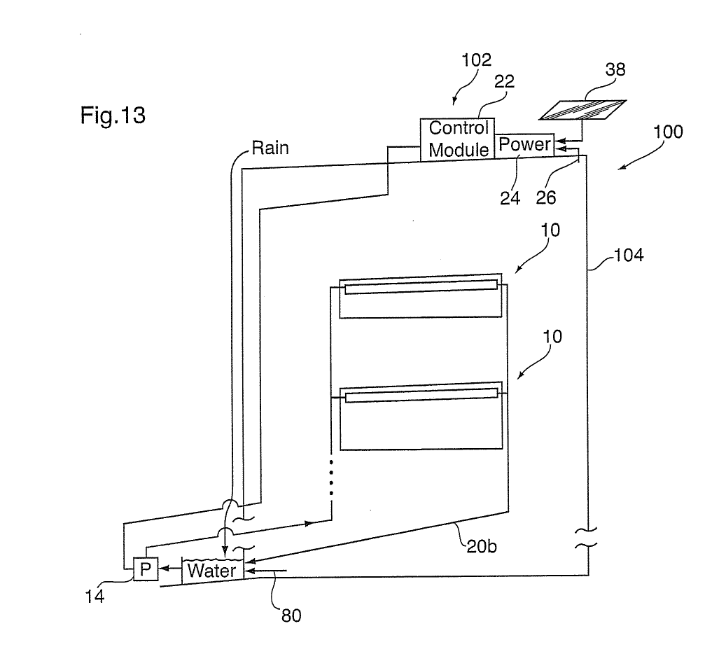

FIG. 13 is a schematic diagram showing an example configuration for a multiple unit garden system controlled from a central location.

### DETAILED DESCRIPTION

Turning now to the figures, FIG. 1 illustrates a schematic diagram of a garden system 10. The garden system 10 comprises a soil containment section for planting and growing plants, referred to hereinafter as a planter 12 for brevity; a pump 14 for supplying water from a water reservoir 16, to the planter 12 via a water delivery line (water line 18 hereinafter); a control module 22 for turning the pump 14 on and off according to a timing signal; a power storage component 24 (e.g. a battery), and a power source 26 for enabling the storage of power. It can be appreciated that the power source 26 and power storage 24 are shown separately for illustrative purposes only and may instead be replaced by a direct power source (e.g. outlet 86—see FIG. 11) or any other suitable device or mechanism in any configuration and comprising any amount of complexity that is capable of providing power to the control module 22 and through the control module 22, the pump 14.

Although optional to the system 10, two example water return paths 20a and 20b are shown. The first water return path 20a is created via a “backward” inclination in the planter 12 such that excess water drains back into the water reservoir 16 against the direction of water flow in the water line 18, instead of dispensing or otherwise wasting the water. The second water return path 20b shown in FIG. 1 also relies on an inclination in the planter 12, but instead uses a “forward” inclination such that any excess water continues to run either within or from the water line 18 and is fed back into the water reservoir 16. It can be appreciated that the two alternative water return paths 20a and 20b are only examples and, in general, any return path 20 can be incorporated into the garden system 10 if so desired.

The planter 12 includes one or more openings, apertures or ports 32 for accommodating the growth of a plant in an area of soil 30 within the planter 12 that is generally aligned with a respective port 32. Any number of ports 32 can be provided, however, as will be explained in greater detail below, a particular number of ports 32 per length of planter 12 is preferred to enable a particular volume of soil per plant. Also, as will be explained below, the ports 32 may be sized such that they satisfy a predetermined ratio of surface area of the port 32 to volume of soil 30 allocated to that port 32 (e.g. by virtue of limiting the number of ports 32 per length of planter 12).

Also shown in FIG. 1, is an enlarged portion of a small length of the water line 18. It can be seen that a passage, hole or perforation 28 is provided in the water line 18 to enable the escape of water into the surrounding area. As will be described below, a perforation 28 can be provided in communication with the water reservoir 16 or a path extending therefrom to inhibit the siphoning of soil from the planter 12. Although only one perforation 28 is shown in FIG. 1 it can be appreciated that additional perforations can be added if required, e.g. according to the nature of the soil being used in the planter 12, the amount of watering required for the particular application, etc. The water line 18 also includes at least one perforation 28 within the planter 18, for example, one perforation 28 aligned with each port 32 to water the surrounding soil 30. It can be appreciated that more than one perforation 28 can be provided for each port 32 if so desired or required by a particular application. Similarly, one port 32 may serve more than one port 32, e.g. if less watering is needed in a particular application. Therefore, the water line 18 can vary in its configuration for different applications or can be adapted for such different applications, e.g. by enabling weakened discs built in the water line 18 to be pierced when needed or plugged when not needed (embodiment not shown for simplicity).

FIG. 2 illustrates an example configuration for the garden system 10a in situ on a balcony railing 42 supported on a cantilevered slab 46, e.g. in an apartment building. It can be seen in FIG. 2 that by balancing the number of ports 32 along the length of the planter 12, a significant reduction in the amount of space required can be achieved, in particular when compared to planter pots that must rest on the slab 46 and take up floor space thereon. The planter 12 can be configured as shown in FIG. 2 to follow the railing 42 without obstructing too much of the railing itself and can be implemented using a tubular structure having any suitable shape (e.g. cylindrical as shown). This can be advantageous in cases wherein the railing 42 permits a sightline and thus the garden system 10 in this configuration would not significantly obstruct an existing view. The planter 12 in this example can be affixed to the railing 42 using a series of straps 44 such as tie wraps or other banding type mechanism.

The planter 12 is this example is serviced by the other components shown in FIG. 1 using a main stack 34 extending from a base 36, with the main stack 34 being fluidly connected to the reservoir 16, which in this example is another length of tube. The main stack 34 provides a fluid connection between the water reservoir 36 and pump 14 and the planter 12 to enable the pump 14 to deliver water to the soil 30 via the water line 18 for growing plants 40. The pump 14 in a configuration such as the one shown in FIG. 2 can be housed in the base 36 such that any water delivered into the water reservoir 16 or returning from the planter 12 can be fed into the pump's inlet. In this example, the planter 12 can be angled in such a way that the terminal end of the planter 12 is slightly higher than its connection point to the stack 34 thus permitting water to drain back towards the pump 14 and water reservoir 16. Also shown in FIG. 2 is a solar panel 38 which may be used to provide the power source 26 shown in FIG. 1 to periodically recharge the power storage component 24.

In addition to the minimal amount of space consumed by the system 10 it can be appreciated from FIG. 2 that the tubular components of the system 10 can be decorated for aesthetic purposes, e.g. by providing different colours, graphics, lighting, etc. Similarly, the system 10 can be incorporated directly into balcony railings, deck railings and other infrastructure to effectively mask its existence. Therefore, the system 10 can be configured to provide not only the functionality described herein but also the aesthetics.

Turning now to FIG. 3, further detail of the stack 34, base 36, and water reservoir 16 is provided for the portion identified by letter “A” in FIG. 2. In this example, it can be seen that the lower portion of the stack 34, the interior of the base 36 and the water reservoir 16 collectively store a supply of water 49 that is made available to the pump 14, which is seated in the base 36. A cap 48 can be provided to enable access to the water reservoir 16. In this way, water can be added to the water reservoir 16 to increase the level of the supply of water 49 as needed. The pump 14 obtains water from the supply 49 and pumps this water through the water line 18, up the stack 34 and into the planter 12. To prevent soil 30 from falling back into the stack and contaminating the water supply 49, a mesh or screen 52 is provided as a barrier between the planter 12 and the stack 34. It may be noted that by using a screen 52, water returning along the bottom of the planter 12 can permeate and return to the water supply 49. It has been found that to enable water to return in the opposite direction to which it is delivered, a tilt of approximately 1 degree from level or 2 inches per every 10 feet of planter 12 is sufficient. However, it has also been found that an incline of anywhere up to 22.5 degrees is also suitable.

In this example, to permit easy access to the power storage component 24 and the control module 22, they can be located at the top of the stack 34 and can be made accessible using another cap 50. This can enable the user to adjust a timer control (not shown), swap batteries, or conduct other maintenance as needed.

FIG. 4 provides further detail of a length of the planter 12 for the portion identified by letter “B” in FIG. 2. The length of the planter 12 shown in FIG. 4 is representative of a section associated with a particular port 32 and thus provides a volume of soil 30 to permit growth of a root system 54 for a particular plant 40. It can be seen that by balancing the number of ports 32 with the length of the planter 12, an adequate volume of soil 30 can be provided to each plant 40 while also restricting the surface area 56 affected by evaporation, i.e. soil 30 that is exposed directly to the exterior of the planter 12. Also, by restricting the surface area, less rain will build up and leave standing water, which can cause problems with insect breeding, etc. In this example, a series of three perforations 28 is shown to illustrate that any desired number of perforations 28 can be used. Each perforation 28 permits a trickle of water 58 to permeate the surrounding soil 30.

As noted above, it has been recognized that by balancing the size and number of the ports 32 with the length of the planter 12, a sufficient volume of soil 30 can be provided to each plant 40 while reducing the amount of surface area 56 prone to evaporation. For the example shown in FIG. 2, it has been found that a surface area of approximately 102 cm² can be achieved for every 4 L volume of soil 30. This is significantly lower than typical cylindrical or square planters (not shown) which may provide up to 350 cm² and 252 cm² respectively for the same volume of soil 30. For trapezoidal planters which have a smaller based than exposed area, the surface area:soil volume ratio is even greater. Although tall planters such as elongated cylindrical units can achieve similar ratios to that of the planter 12, the height and weight of such planters is contrary to the benefits of the compact and space efficient system 10 described herein. A suitable range of ratios for port surface area to soil volume is 50 cm²/L or less. It can be appreciated, however, that the system 10 can also be adapted to have a ratio outside of this range in some applications, for example, where flowers or other small plants are grown and a greater number of ports 32 is desired or required.

It may also be noted from FIG. 4 that the water line 18 is advantageously suspended or otherwise located near the upper portion of the planter 12 such that it is configured to make minimal contact with the soil 30, in particular near the perforations 28. This may be done to minimize the amount of soil 30 that is siphoned through the water line 18 and back into the pump 14 when the pump 14 is turned off (when a check valve is not used). Also, by placing the water line 18 towards the top of the planter 12, a greater amount of the water trickle 58 from the water line 18 is provided to the roots 54, regardless of the stage of the plant's development. Again, as shown in FIG. 4 by way of example, although one a single perforation 28 is required, any number of perforations 28 may be used to serve any number of ports 32 (e.g. 3 per port 32 as shown).

Instead of the return path 20a that is provided in the configuration shown in FIGS. 2 to 4, different configurations for the planter 12 and water reservoir 16 can enable the return path 20b to be provided. FIG. 5 is one such configuration for the system 10b, wherein the water reservoir 16 is fluidly connected to the terminus of the planter 12 and the planter itself declined from level by an angle θ, wherein θ can be 1°-22.5° from level as noted above. In this way, any excess water from that fed into the soil 30 within the planter 12 can continue back through a terminal screen 52 and into the water reservoir 16. The cap 48 can be placed above the intersection of the planter 12 and water reservoir 16 as shown to enable the user to determine the water level and add water to the supply 49. By considering the flow of water from pump 14 to soil 30 and back to the water reservoir 16 enables the system 10 to recapture water that is not needed by the plants 40 at that time. This can then accommodate the different amounts of water needed at different stages of development without necessarily requiring an adjustment to the timing mechanism using by the control module 22.

Another example configuration for the system 10c is shown in FIG. 6, which provides a return path 16b through a declination of the planter 12. In this example, a larger water reservoir 16 is provided while enabling the system 10c to be self-standing. An auxiliary leg 66 is spaced from the base 36 such that it is generally aligned with the terminus of the planter 12 to provide stability. The cap 48 providing access to the water reservoir 16 in this example is provided through a separate extension 67 along a bottom length of tube 64. It can be appreciated that as shown in FIG. 6, the height of the cap 48 (in this case due to the height of the extension 67) can be raised or lowered to increase or decrease the capacity of the water reservoir 16 since the overall water level is affected by the height of the access point to the water reservoir 16. In this example, by extending the extension 67, the overall water level could be increased. However, it can be appreciated that the cap 48 can be placed in any other suitable location such as along a return section 62 or on the side of the stack 34.

Yet another example configuration for the system 10d is shown in FIG. 7, wherein a pair of return paths 20b are provided and two lengths of planter 12 are provided to enable it to follow two walls. The system 10d shown in FIG. 7 is also free-standing due to the provision of a pair of auxiliary legs 66 that are spaced at either end of the planter 12 spaced from the base 36. In this example, the pump 14 and the base 36 are located centrally such that the water line 18 splits to feed either side of the planter 12 thereby providing the two return paths 20b. The cap 50 can be placed in alignment with the pump 14 as shown or the other components to be accessed through such a cap 50 can be located elsewhere. In this example, an even larger water reservoir 16 is provided by having a pair of bottom lengths of tube 64 and a pair of return sections 62. It can be appreciated that as shown in FIG. 7, any number of lengths of planter 12 sections can be incorporated into any configuration for the water reservoir 16. For example, several tiers could be included by adding more depth to the structure along with the requisite connections back to the water reservoir 16 if so desired.

Yet another free-standing configuration for the system 10e is shown in FIG. 8. In this example, the stack 34 and return section 62 each extend from one end of the planter 12 towards each other to join at the base 36 forming a triangular shape. By providing a suitably sized base 36, the system 10e shown in FIG. 8 can be free-standing. It can therefore be appreciated that various configurations can be used to provide various sizes and shapes for the system 10 and its water reservoir 16 to balance size, water capacity, and aesthetics. Also, by including a water reservoir 16, a direct connection to a water supply such as a water tap (either interior or exterior) is not required. With a large capacity and, depending on the watering cycle, the user may not need to tend to the system 10 each and every day.

Where a direct water supply 80 is available, as shown in FIG. 9, a hose 78 or other supply line can be used to connect the system 10 to the water supply 80. This can be done to provide a convenient way to manually refill the water reservoir 16, or can be used with a more complex configuration to permit a self-filling system 10. In the example shown in FIG. 9, the hose 78 is coupled to the stack 34 using a standard fitting 76, however, a valve 74 or other flow restricting device is provided to permit or block the flow of water from the water supply 80 into the water reservoir 16. By using a water level sensor 72, the valve 74 can be configured to operate automatically according to the level in the water reservoir 16. For example, although not shown in detail in FIG. 9, the water level sensor 72 can be calibrated to detect both a lower limit and an upper limit to thereby enable a filling state when the water level reaches a predetermined lower threshold or limit, and conversely stop the filling state when the water level reaches a predetermined upper threshold or limit. By incorporating a direct connection to the water supply 80 and permitting detection of the water level in the water reservoir 16, an automatic replenishment of the water available to the pump 14 can be made automatic. Instead of or in addition to providing an automatic refill cycle, the system 10 can include access to a rain collector (not shown) or any other water source that can limit the amount of water required from the water supply 80 and to recycle any available water in the environment.

As discussed above, the control module 22 enables the pump 14 to be run according to a timer, which can be programmed with any level of sophistication. For the sake of illustration, it is assumed that the control module 22 is programmed to operate the pump 14 for X number of minutes, Y times per day. For example, a morning watering and an evening watering. If further sophistication is desired, the amount of water in the soil 30 can be estimated using a humidity sensor 82 as shown in FIG. 10. The humidity sensor 82 can provide a measurement indicative of the amount of water in the soil 30 to the control module 22 to provide finer control over the watering cycle. In one configuration, when the soil 30 becomes too dry, the pump 14 can be run for a calibrated mono-stable interval, rather than simply watering on normal, regular intervals. Conversely, content threshold overrides can be incorporated in order to better control overwatering in an automatic watering cycle. In a normal periodic watering cycle (e.g. once every 10 hours), the humidity sensor 82 can be used to reduce the delivery of water when integrated directly into the timing controller 88 as shown in FIG. 12A. Therefore, the humidity sensor 82 can be used to perform any number of operations to better control the moisture content in the soil 30. In even more sophisticated embodiments, the control module 22 can be programmed according to different plant profiles to utilize different watering cycles achieving different consistent moisture levels, according to the particular application.

Also, in other configurations, one or more photo-resistors 91 can be used (see also FIG. 11) to enable the control module 22 to obtain and utilize a measure of daily lumina, which can be a good indicator of atmospheric humidity (in addition to photosynthesis energy supply). Such a measure of daily lumina may then be used to adjust the watering according to a correlation between the estimated atmospheric humidity and water requirements. The use of photo resistors 91 can also inhibit watering cycles at night, a practice that presents a risk of root-rot. Furthermore, a lumen threshold switch could be incorporated into the design in order to select between a mono-stable timing-circuit and a high resistance idle load. To take advantage of times where an idle load is available, in such configurations, auxiliary electrical equipment such as LED novelty lighting could be incorporated into the design to provide an additional aesthetic feature to the garden system 10 while providing an alternate load when the mono-stable timing circuit is not being used. Such a lighting system can be configured to operate on a lumen threshold circuit so as to turn off during the day, should a different irrigation calibration be used. Therefore, the one or more photo-resistors 91 can also be used to perform any number of operations both to better control the moisture content in the soil 30, according to plant profile, and/or to control other potential aesthetic features of the garden system 10.

As can be seen from the above, various levels of automation and sophistication can be incorporated into the system 10 by incorporating sensors and predetermined intelligence, and programming the control module 22 accordingly. FIG. 11 illustrates an example electrical schematic for incorporating various automation options. On the power side, the power storage component 24 in this case a battery can be charged by a solar panel 38 or a separate charger 84 (e.g. one that is plugged into an outlet 86). Alternatively, if an outlet 86 is readily available, the battery 24 can be bypassed or eliminated. Similarly, if a direct connection to the electrical system of for example a house or building is available, the system 10 can be wired in directly.

The control module 22 in this example comprises a timing controller 88 such as an off-the-shelf micro controller or chip that can be programmed to provide a timing pulse to operate the pump 14. The timing pulse is configured such that when it is “ON” or “HIGH”, power is provided and when it is “OFF” or “LOW”, no power is provided. This can be done by blocking or permitting power to the pump 14 through a pump switch 90 (e.g. a transistor, relay, etc.) via a control signal (CTRL). However, as discussed above, sensors such as the humidity sensor 82 can be used to more intelligently control the watering cycle. In this case, the humidity sensor 82 provides an input to the timing controller 88 that can be interpreted to adjust the normal timing and control of the pump 14. As also shown in FIG. 11, the photo-resistor 91 can also be linked into the control module 22 to measure daily lumina to estimate atmospheric humidity as mentioned above.

Photo-resistors 91 could be incorporated directly into the timing controller's circuitry (see also FIG. 12 to be explained below) to alter the resistance value that controls the idle timing of the circuit. In this way, the watering cycle would be adjusted according to brightness in the atmosphere—e.g. relatively shortened during bright, sunny, dry days and relatively lengthened or shortened less so on deeply overcast humid days. For example, in practice, during a bright, unclouded daylight period of 16 hours (where plants should receive ample energy to synthesize sugars, carbohydrates and cellulose), up to three watering periods may be needed per day (providing ample water and nutrients to meet demand). On the other hand, shorter, deeply overcast days can be given only one or two watering periods as the demand is presumably much lower. In this manner, the timing controller 88 can even more accurately predict the water requirements of the plants it is responsible for, and conserve battery life on days where the solar panel 38 (if used) is less able to provide a charge.

In addition to controlling the watering cycle, the water level sensor 72 can provide an additional input to the timing controller 88 indicative of when the reservoir 16 needs replenishing and when this process is complete. The timing controller 88 may then provide a CTRL signal to a water switch 92 controlling operation of the valve 74 permitting or blocking the water supply 82 to feed the water reservoir 16. Alternatively, the water level sensor 72 may be connected directly to one or more water switches 92 to control the water replenishment cycle independent of the timing controller 88. Similarly, the control of the water level can be done through a separate module (not shown) and is shown as part of the control module 22 for illustrative purposes only. It can be appreciated that the schematic shown in FIG. 11 is only one configuration and thus various other configurations using various available technologies can be used according to what is available and required by the application.

FIG. 12A illustrates an example circuit diagram for one configuration of an a-stable timing controller 88. In this example, it can be seen that a commercially available, off-the-shelf integrate circuit (IC) is used—a 555 timer IC 89 that is well known in the art. The timer IC 89 relies on changes in resistance as measured by the humidity sensor 82 and the photo-resistor 91 to control the idle timing as mentioned above. To achieve this, the humidity sensor 82 is connected in series with resistor Ra, and the photo-resistor 91 is connected in series with Rb. The control signal that is output on pin 3 would then be fed into the switch 90, e.g. a transistor, relay, etc. As can also be seen, pins 8 and 4 are connected to the battery 24 and the clock control resistive portion of the circuit. The diode enables <50% duty cycles on the IC 89. The capacitor linked to pin 5 (Cb) can be used as a faulty reset signal inhibitor. The other capacitor (Ca) helps determine the IC 89 timing with resistive segments Ra and Rb.

As discussed above, the timing controller 88 can also be configured as a mono-stable circuit. An example of such a mono-stable configuration is shown in FIG. 12B and is denoted by numeral 88′ for clarity. The mono-stable circuit 88′ can be considered a “one-shot” circuit, when powered on. Such a circuit 88′ could be used in applications that utilize, for example, a single morning watering (on a lumen based threshold circuit) for flowers.

It may also be noted that the timing of the circuit can vary with variations to capacitance and resistance, for example, it has been found that an appropriate duty cycle should be in the neighbourhood of 0.15%, and to achieve meaningful ‘on’ cycles—should last no less than 40 seconds (in order to at least charge the whole water line 18 with water). Of course, these figures are dependent on the capacity of the pump, but would not change greatly based on currently available fluid pumps.

The above embodiments illustrate a self-contained system 10 that can provide various levels of automation and sophistication. The principles discussed herein can be extended to wider systems 100 comprising a plurality of individual systems 10 connected to a main control center 102 serving an entire building 104 as shown in FIG. 13. It can be seen that the system 10 can easily be scaled to provide an extensive network of units serving multiple users from a central location. Similar components can be used that are scaled for the size of the overall system 100. For example, a larger reservoir 16, more powerful pump 14, appropriately programmed control module 22 (e.g. multiplexed to serve units with different watering schedules or to vary the flow of water to manage the water supply), and appropriate power storage 24 and/or supply 26 can be used.

In another example embodiment (not shown), a system 100 such as that shown in FIG. 13 can be configured to be suitable for a roof-top garden. In traditional roof-top gardens, large quantities of water bearing soil in planters or laden directly on the roof, whereas by incorporating a manifestation of the system 100 shown in FIG. 13, the rain-fed reservoir could be located on ground level with several perceived benefits. For example, architectural concerns such as weight distribution and rooftop contact humidity (possibly leading to leaks or collapse) among others can be addressed. The system 100 could be laid out similar to a farm with long runs of planters 12. Such a concept could be particularly advantageous to establishments such as restaurants with access to roofs. Also, grocery stores and industrial or commercial spaces with large flat roofs could also incorporate roof-top gardens of this variety. Where available, solar power can be incorporated to provide a self-sustaining system.

Although the above principles have been described with reference to certain specific embodiments, various modifications thereof will be apparent to those skilled in the art without departing from the scope of the claims appended hereto.

1. A garden system comprising:
a planter for containing soil for growing one or more plants, the planter comprising at least one port for permitting plant growth therethrough;
a water source;
a pump connected to the water source at a pump inlet;
a water line connected to a pump outlet, the water line extending into the planter for delivering water to soil contained in the planter;
a power source for powering the pump for delivering water from the water source to the water line; and
a control module connected between the power source and the pump to provide a timing signal to the pump for delivering water according to a water cycle.

2. The garden system according to claim 1, further comprising an overflow return to deliver excess water from the planter to a water reservoir, the water reservoir providing the water source.

3. The garden system according to claim 2, wherein the planter is configured to be tilted to provide a return path in the opposite direction of the direction of water flow from the water line.

4. The garden system according to claim 2, wherein the planter is fluidly connected to a return section at a terminal end thereof for returning water to the water reservoir, the return section also being fluidly connected to the water reservoir.

5. The garden system according to claim 1, wherein the power source is a power storage component, the power storage component being capable of recharging.

6. The garden system according to claim 5, wherein the power storage component is connected to a solar panel for recharging.

7. The garden system according to claim 1, further comprising a humidity sensor located in the planter for measuring soil humidity, the humidity sensor being connected to the control module to provide information for adjusting the watering cycle.

8. The garden system according to claim 1, further comprising a photo-resistor connected to the control module for measuring external brightness to provide information for adjusting the watering cycle.

9. The garden system according to claim 1, further comprising a water level sensor configured to interface with the water source to determine a water level in a water reservoir, wherein the water level sensor is connected to the control module to enable the control module to control a water supply connected to the water reservoir for replenishing same.

10. The garden system according to claim 1, wherein the planter comprises an elongated tubular body configured to be attached to a railing.

11. The garden system according to claim 10, wherein the pump and water source are in fluid communication with a stack, the stack being connected to the tubular body thereby providing a self-contained system.

12. The garden system according to claim 11, wherein the tubular body comprises one or more screens contained therein to separate soil from the water source.

13. The garden system according to claim 1, wherein the water line comprises at least one perforation, each perforation corresponding to a respective port for delivering water to a respective plant.
